(19) United States
(12) Patent Application Publication
(10) Pub. No.: US 2020/0082977 A1
(43) Pub. Date: Mar. 12, 2020

(54) TRANSFORMER AND SIGNAL TRANSMISSION SYSTEM

(71) Applicant: KABUSHIKI KAISHA TOSHIBA, Minato-ku (JP)

(72) Inventor: Hiroaki Ishihara, Yokohama (JP)

(73) Assignee: KABUSHIKI KAISHA TOSHIBA, Minato-ku (JP)

(21) Appl. No.: 16/290,083

(22) Filed: Mar. 1, 2019

(30) Foreign Application Priority Data
Sep. 7, 2018 (JP) 2018-168199

(51) Int. Cl. H01F 27/34; H01F 19/00; H01F 27/28

(52) U.S. Cl. CPC H01F 27/346; H01F 27/29; H01F 27/2804; H01F 19/00

(57) ABSTRACT

A transformer includes a first coil disposed on a first surface, a second coil disposed on the first surface so as to surround the first coil, a third coil disposed on a second surface that is vertically adjacent to the first surface with an insulating layer, and a fourth coil disposed on the second surface so as to surround at least a part of the third coil, and when a current is caused to flow through the first coil, the first coil generates magnetic fluxes that pass through the first coil in opposite directions, and when the current is caused to flow through the first coil, the magnetic fluxes generated by the first coil pass through the first coil in opposite directions, and when a current is caused to flow through the second coil, the second coil generates magnetic fluxes that pass through the second coil in a single direction.

### CROSS REFERENCE TO RELATED APPLICATIONS

This application is based upon and claims the benefit of priority from the prior Japanese Patent Application No.

2018-168199, filed on Sep. 7, 2018, the entire contents of which are incorporated herein by reference.

### FIELD

Embodiments described herein relate generally to transformers and signal transmission systems.

### BACKGROUND

A technique relating to isolators used in signal transmission is known, in which signals are transmitted by a transformer including winding parts disposed to two layers that are vertically arranged with an insulating film disposed therebetween. If used in signal transmission for transmitting a plurality of sets of signals, such transformers preferably have a smaller size with reduced interference between the transmission side and the reception side.

For example, a transformer is proposed, in which series-connected two winding parts are disposed on each of two surfaces vertically arranged with an insulating film disposed therebetween, and the directions of magnetic fields generated by the respective winding parts are set to be opposite to each other to reduce the magnetic field leakage. The two winding parts disposed on the two surfaces are necessary in order to transmit one set of signals. Therefore, there is a problem in that the size of the transformer cannot be reduced.

### BRIEF DESCRIPTION OF THE DRAWINGS

FIG. 1 is a perspective view of a transformer according to a first embodiment.

FIG. 2 is a plan view of a first coil and a second coil on a first surface.

FIG. 3 is a diagram illustrating an example in which a current is caused to flow through the first coil on the first surface in a direction shown in the diagram.

FIG. 4 is a diagram illustrating an example in which a current is caused to flow through the second coil on the first surface in a direction shown in the diagram.

FIG. 5 is a plan view of a first modification of a first winding part and a second winding part included in the first coil.

FIG. 6 is a plan view of a second modification of the first winding part and the second winding part included in the first coil.

FIG. 7A is a block diagram of a first example of a signal transmission system.

FIG. 7B is a block diagram of a second example of the signal transmission system.

FIG. 8 is a perspective view of for explaining an example in which two transformers according to the embodiment are used to improve the breakdown voltage.

FIG. 9 is a diagram illustrating a first modification of the first coil and the second coil on the first surface 2.

FIG. 10 is a diagram illustrating a second modification of the first coil and the second coil on the first surface 2.

FIG. 11 is a diagram illustrating a third modification of the first coil and the second coil on the first surface 2.

FIG. 12 is a diagram showing an example in which a tap terminal is disposed on a path connecting the first coil and the second coil on the first surface 2.

### DETAILED DESCRIPTION

A transformer includes:

a first coil disposed on a first surface;

a second coil disposed on the first surface so as to surround at least a part of the first coil;

a third coil disposed on a second surface that is vertically adjacent to the first surface with an insulating layer being disposed between the first surface and the second surface; and

a fourth coil disposed on the second surface so as to surround at least a part of the third coil,

wherein when a current is caused to flow through the first coil, the first coil generates magnetic fluxes that pass through the first coil in opposite directions, the magnetic fluxes inducing an electromotive force in the third coil,

wherein when the current is caused to flow through the first coil, the magnetic fluxes generated by the first coil pass through the first coil in opposite directions, the magnetic fluxes causing electromotive forces induced in the second coil and the fourth coil to be canceled;

wherein when a current is caused to flow through the second coil, the second coil generates magnetic fluxes that pass through the second coil in a single direction, the magnetic fluxes causing an electromotive force induced in the first coil and the electromotive force induced in the third coil to be canceled, and

wherein when the current is caused to flow through the second coil, the magnetic fluxes passing through the second coil in the single direction induce the electromotive force in the fourth coil.

### First Embodiment

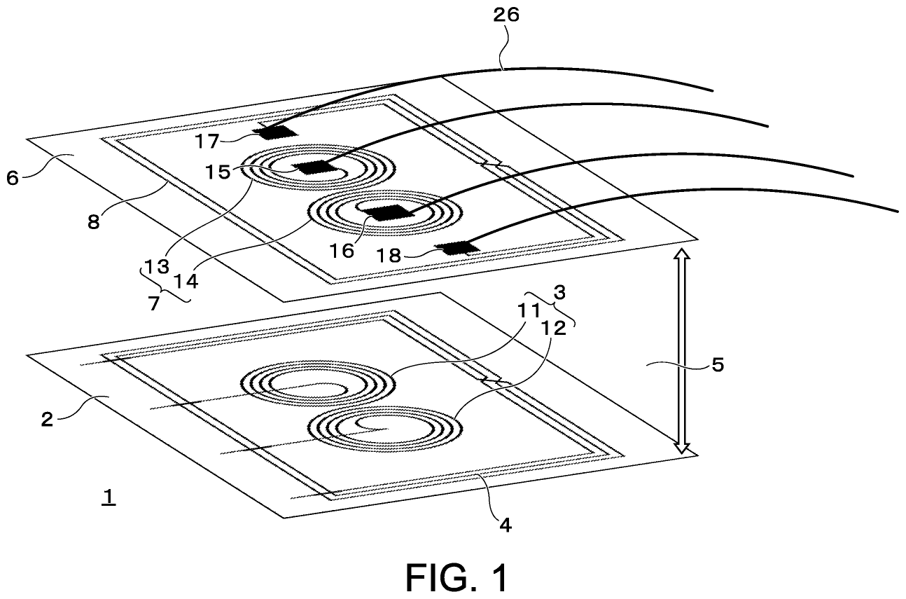

FIG. 1 is a perspective view of a transformer 1 according to a first embodiment. The transformer 1 shown in FIG. 1 is used for differential signal transmission, for example. More specifically, the transformer 1 shown in FIG. 1 transmits two sets of differential signals with the transmission side and the reception side being electrically isolated from each other.

The transformer 1 shown in FIG. 1 includes a first coil 3 disposed on a first surface 2, a second coil 4 disposed on the first surface 2 so as to surround at least a part of the first coil 3, a third coil 7 disposed on a second surface 6 that is arranged to be vertically adjacent to the first surface 2 with an insulating layer 5 disposed therebetween, and a fourth coil 8 disposed on the second surface 6 so as to surround at least a part of the third coil 7. The first to fourth coils 3, 4, 7, and 8 are formed to have a spiral shape using a conductive pattern or a wiring line pattern on the first surface 2 or the second surface 6.

When a current is caused to flow through the first coil 3, the first coil 3 generates magnetic fluxes passing through the first coil 3 in opposite directions to induce an electromotive force in the third coil 7. Furthermore, the magnetic fluxes passing through the first coil 3 in the opposite directions when the current flows through the first coil 3 cause electromotive forces induced in the second coil 4 and the fourth coil 8 to be canceled.

When a current is caused to flow through the second coil 4, the second coil 4 generates magnetic fluxes passing through the second coil 4 in a single direction, which magnetic fluxes cause electromotive forces induced in the second coil 4 and the fourth coil 8 to be canceled. Furthermore, the magnetic fluxes passing through the second coil 4 in the single direction when the current flows through the second coil 4 induce an electromotive force in the fourth coil 8.

When a current is caused to flow through the third coil 7, the third coil 7 generates magnetic fluxes passing through the third coil 7 in opposite directions, to induce an electromotive force in the first coil 3. Furthermore, the magnetic fluxes passing through the third coil 7 in the opposite directions when the current flows through the third coil 7 cause the electromotive forces induced in the second coil 4 and the fourth coil 8 to be canceled.

When a current is caused to flow through the fourth coil 8, the fourth coil 8 generates magnetic fluxes passing through the fourth coil 8 in a single direction, which magnetic fluxes cause electromotive forces induced in the first coil 3 and the third coil 7 to be canceled. Furthermore, the magnetic fluxes passing through the fourth coil 8 in the single direction when the current flows through the fourth coil 8 induces an electromotive force in the second coil 4.

The first coil 3 has a first winding part 11 and a second winding part 12 that are connected in series and wound in opposite directions. The second coil 4 is disposed to surround at least a part of the first winding part 11 and the second winding part 12. The third coil 7 has a third winding part 13 and a fourth winding part 14 that are connected in series and wound in opposite directions. The fourth coil 8 is disposed to surround at least a part of the third winding part 13 and the fourth winding part 14.

The first winding part 11 and the second winding part 12 in the transformer 1 shown in FIG. 1 are arranged so that, when the current flows through the first coil 3, the direction of the magnetic flux passing through the first winding part 11 and the direction of the magnetic flux passing through the second winding part 12 are opposite to each other, and that, when the current flows through the second coil 4, the electromotive force induced in the first coil 3 is caused to be canceled by the magnetic fluxes passing through the first winding part 11 and the second winding part 12 in the single direction. The third winding part 13 and the fourth winding part 14 are arranged so that, when the current flows through the first coil 3, the magnetic flux passing through the first winding part 11 and the magnetic flux passing through the second winding part 12 induce the electromotive force in the third coil 7, and that, when the current flows through the second coil 4, the electromotive force induced in the third coil 7 is caused to be canceled by the magnetic fluxes passing through the third winding part 13 and the fourth winding part 14.

Instead of causing the current to flow through the first coil 3 or the second coil 4, the transformer 1 shown in FIG. 1 is capable of causing a current to flow through the third coil 7 or the fourth coil 8. In this case, the third winding part 13 and the fourth winding part 14 are arranged so that, when the current flows through the third coil 7, the direction of a magnetic flux passing through the third winding part 13 and the direction of a magnetic flux passing through the fourth winding part 14 are opposite to each other, and that, when the current flows through the fourth coil 8, the magnetic fluxes passing through the third winding part 13 and the fourth winding part 14 in a single direction cancel an electromotive force induced in the third coil 7. The first winding part 11 and the second winding part 12 are arranged so that, when the current flows through the third coil 7, the magnetic flux passing through the third winding part 13 and the magnetic flux passing through the fourth winding part 14 induce an electromotive force in the first coil 3, and that, when the current flows through the fourth coil 8, magnetic fluxes passing through the first winding part 11 and the second winding part 12 cancel the electromotive force induced in the first coil 3.

In the transformer 1 shown in FIG. 1, the first to fourth winding parts 11 to 14 are positioned so that, when the current flows through the first coil 3, at least a part of the magnetic flux passing through the first winding part 11 also passes through the third winding part 13, and at least a part of the magnetic flux passing through the second winding part 12 also passes through the fourth winding part 14.

On the second surface 6, a first pad 15 and a second pad 16 are disposed to be electrically connected to both ends of the third coil 7, and a third pad 17 and a fourth pad 18 are disposed to be electrically connected to both ends of the fourth coil 8.

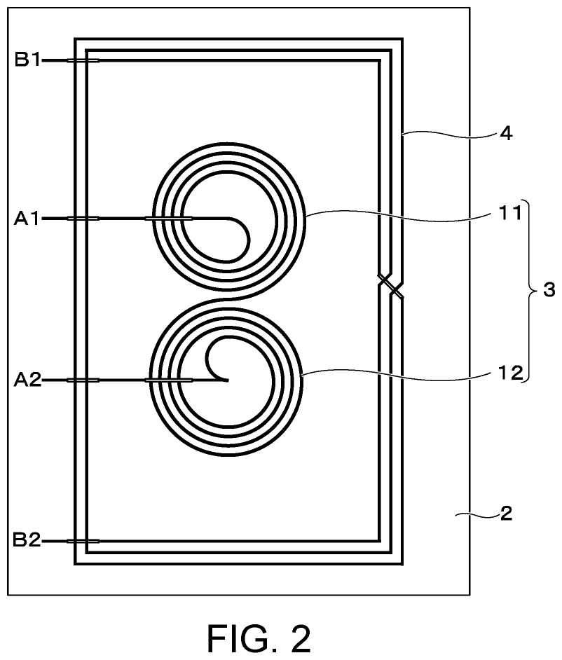

FIG. 2 is a plan view of the first coil 3 and the second coil 4 on the first surface 2. The shapes and the positions of the third coil 7 and the fourth coil 8 on the second surface 6 are the same as those of the first coil 3 and the second coil 4. As shown in FIG. 2, each of the first winding part 11 and the second winding part 12 in the first coil 3 has a spiral shape and disposed on the first surface 2. One end of the first winding part 11 is electrically connected to a terminal A1. The other end of the first winding part 11 is continuously connected to one end of the second winding part 12, and the other end of the second winding part 12 is electrically connected to a terminal A2. As shown in FIG. 2, the first winding part 11 and the second winding part 12 are rotationally symmetric.

The second coil 4 is disposed to surround the first winding part 11 and the second winding part 12. In the example of FIG. 2, the first coil 3 is in a circular shape, and the second coil 4 is in a rectangular shape. However, as will be described later, the specific shapes of the first coil 3 and the second coil 4 are not limited to those shown in FIG. 2. One end of the second coil 4 is electrically connected to a terminal B1, and the other end is electrically connected to a terminal B2. In the example of FIG. 2, the second coil 4 is wound a plurality of times. However, the second coil 4 may be wound only once. If the second coil 4 is wound a plurality of times, the conductive pattern of the second coil 4 is crossed. Therefore, the turns of the second coil 4 should be disposed in an upper layer and a lower layer with a contact disposed therebetween so as to be crossed.

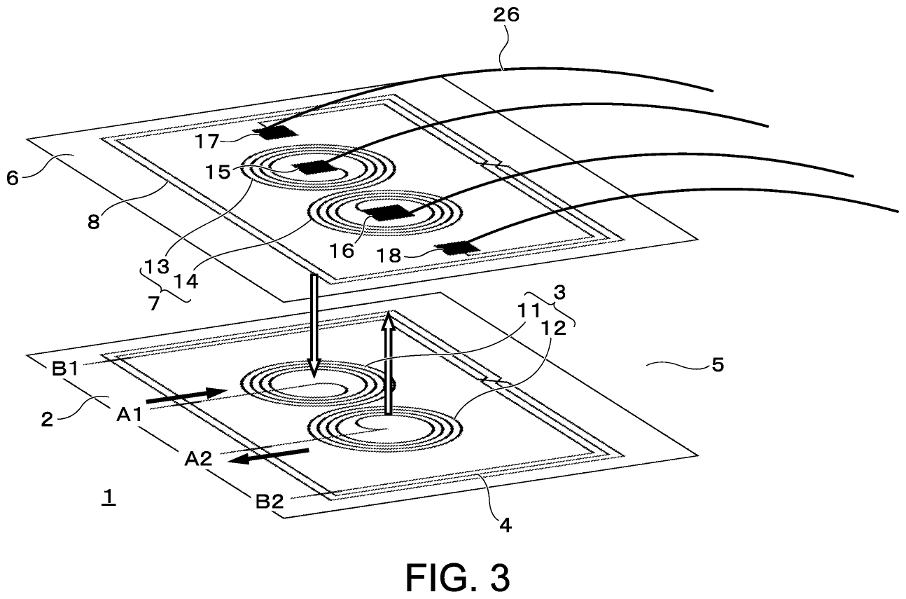

FIG. 3 shows an example in which a current is caused to flow through the first coil 3 on the first surface 2 in a direction shown in the diagram. Since the direction of the turns in the first winding part 11 and the direction of the turns in the second winding part 12 included in the first coil 3 are opposite to each other, the direction of the current flowing through the first winding part 11 and the direction of the current flowing through the second winding part 12 are opposite to each other. Thus, the direction of the magnetic flux generated by the first winding part 11 is downward, and the direction of the magnetic flux generated by the second winding part 12 is upward. As a result, the magnetic flux generated by the first winding part 11 passes through the third winding part 13 of the third coil 7 on the second surface 6, and the magnetic flux generated by the second winding part 12 passes through the fourth winding part 14. Therefore, an electromotive force is induced between the pad 15 and the 16 connected to the ends of the third winding part 13 and the fourth winding part 14 as a function of the magnetic flux. Due to the induced electromotive force, a signal is transmitted from the first coil 3 to the third coil 7 with the third coil 7 being electrically isolated from the first coil 3.

Since the direction of the magnetic flux generated by the first winding part 11 and the direction of the magnetic flux generated by the second winding part 12 are opposite to each other, those magnetic fluxes are canceled by each other in the second coil 4. As a result, the influence of the magnetic fluxes generated by the first winding part 11 and the second winding part 12 to the second coil 4 is reduced. Therefore, no electromotive force is induced in the second coil 4, and leakage magnetic flux from the second coil 4 to the outside is suppressed. Similarly, the magnetic flux passing through the third winding part 13 and the magnetic flux passing through the fourth winding part 14 on the second surface 6 cancel each other, and therefore no induced electromotive force is generated in the fourth coil 8 and leakage magnetic flux from the fourth coil 8 to the outside is suppressed.

The same can be said when a current is caused to flow through the third coil 7 on the second surface 6, which case is opposite to the case shown in FIG. 3. An electromotive force is induced between the pads 15 and 16 at the ends of the first winding part 11 and the second winding part 12 included in the first coil 3, and a signal is transmitted from the third coil 7 to the first coil 3 in an isolated manner. On such an occasion, leakage magnetic fluxes from the second coil 4 and the fourth coil 8 to the outside can be suppressed.

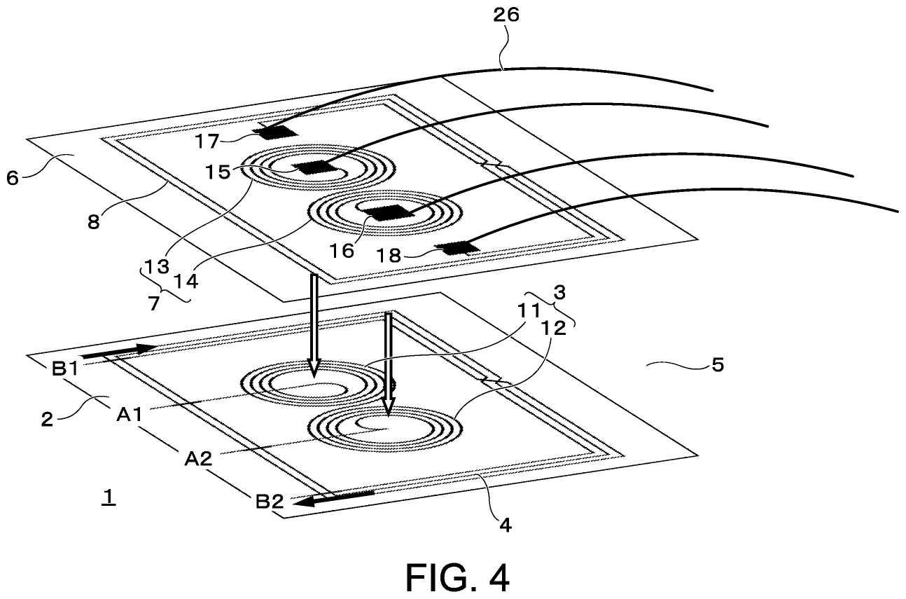

FIG. 4 shows an example in which a current is caused to flow through the second coil 4 on the first surface 2 in the direction shown in FIG. 4. In this case, the magnetic fluxes in the direction shown by the arrows is generated in the second coil 4, at least a part of the magnetic fluxes passing through the first winding part 11 and the second winding part 12 of the first coil 3. As described above, the first winding part 11 and the second winding part 12 are rotationally symmetric. Therefore, the electromotive force induced in the first winding part 11 and the electromotive force induced in the second winding part 12 cancel each other, and substantially no electromotive force is induced between the terminal A1 and the terminal A2. The magnetic fluxes also pass through the fourth coil 8 on the second surface 6. This induces an electromotive force between the pads 17 and 18 at the ends of the fourth coil 8. Due to the induced electromotive force, a signal may be transmitted from the second coil 4 to the fourth coil 8 in an electrically isolated manner. Since the third winding part 13 and the fourth winding part 14 of the third coil 7 on the second surface 6 are rotationally symmetric, substantially no electromotive force is induced between the pads 15 and 16 at the ends of the third winding part 13 and the fourth winding part 14.

The same can be said when a current is caused to flow through the fourth coil 8 on the second surface 6, which case is opposite to the case shown in FIG. 4. A signal may be transmitted from the fourth coil 8 to the second coil 4 in an electrically isolated manner. The magnetic fluxes generated by the second coil 4 induce substantially no electromotive force in the first coil 3, and the magnetic fluxes passing through the fourth coil 8 induces substantially no electromotive force in the third coil 7.

Thus, the signal transmission between the first coil 3 and the third coil 7 causes substantially no mutual interference between the second coil 4 and the fourth coil 8, and the signal transmission between the second coil 4 and the fourth coil 8 causes substantially no mutual interference between the first coil 3 and the third coil 7.

The first winding part 11 and the second winding part 12 in the first coil 3 are required to generate magnetic fields with the same amplitude in opposite directions, in response to the same current. For this purpose, the first winding part 11 and the second winding part 12 on the first surface 2 are preferably rotationally symmetric, mirror symmetric, axisymmetric, or point symmetric. Similarly, the third winding part 13 and the fourth winding part 14 on the second surface 6 are preferably rotationally symmetric, mirror symmetric, axisymmetric, or point symmetric. The first to fourth winding parts 11 to 14 are each formed of a conductive member such as a conductive pattern, which has at least one of a curved portion and a linear portion that is bent at two or more points. The conductive member is not necessarily rotationally symmetric, mirror symmetric, axisymmetric, or point symmetric for the entire length, but may be rotationally symmetric, mirror symmetric, axisymmetric, or point symmetric for the main part (for example, the spiral part).

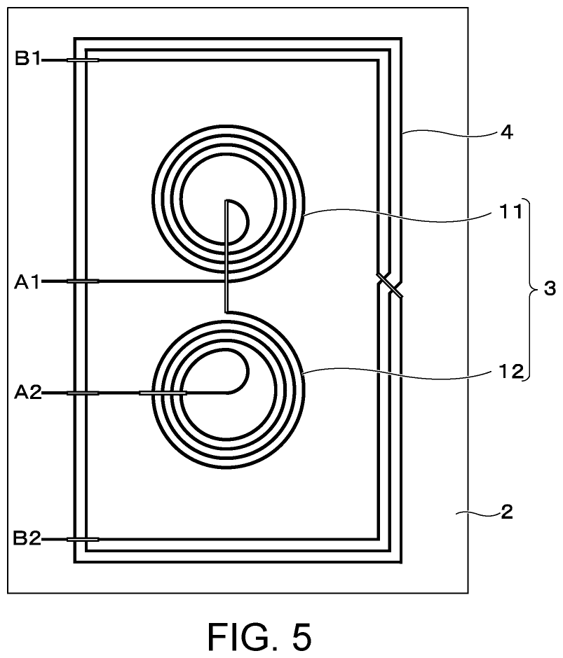

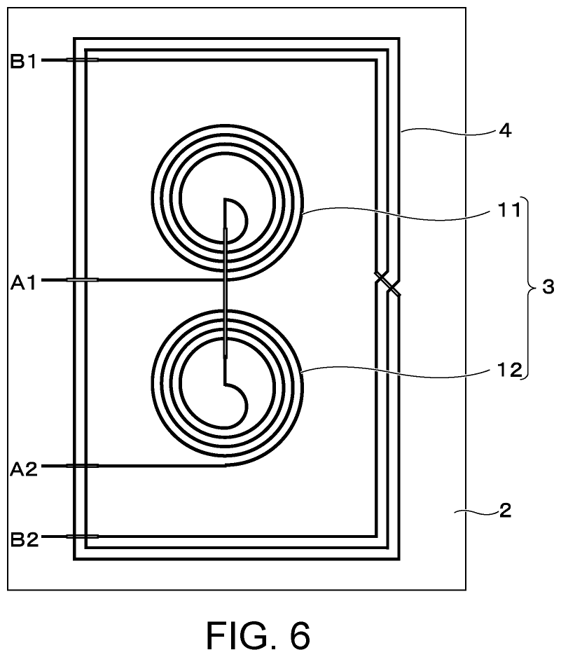

The shapes of the first winding part 11 and the second winding part 12 of the first coil 3 are not necessarily those shown in FIG. 2. FIG. 5 shows an example of a plan view of a first modification of the first winding part 11 and the second winding part 12 included in the first coil 3. In FIG. 5, the first winding part 11 and the second winding part 12 are arranged to be mirror symmetric. FIG. 6 is a plan view of a second modification of the first winding part 11 and the second winding part 12 included in the first coil 3. In FIG. 6, the first winding part 11 and the second winding part 12 have the same shape. The shapes shown in FIGS. 2, 5 and 6 may also be applied to the third coil 7 and the fourth coil 8 on the second surface 6.

The first coil 3 and the second coil 4 may be formed on the first surface 2 of a predefined layer (“first layer”) on a semiconductor substrate. The third coil 7 and the fourth coil 8 may be formed on the second surface 6 of a second layer that is disposed to be vertically adjacent to the first layer on the semiconductor substrate with the insulating layer 5 being disposed therebetween. Since other semiconductor elements are formed on the semiconductor substrate, the first to fourth coils 3, 4, 7, and 8 may be formed as wiring line patterns during the step of forming wiring lines in a process of manufacturing the semiconductor elements, and the insulating layer 5 may be formed between the wiring line patterns during the step of forming the insulating layer 5.

Alternatively, the first coil 3 and the second coil 4 described above may be formed on the first surface 2 of a predefined layer (“first layer”) of a printed wiring board including multiple layers. The third coil 7 and the fourth coil 8 may be formed on the second surface 6 of a second layer that is disposed to be vertically adjacent to the first layer of the printed wiring board with the insulating layer 5 being disposed therebetween. Since a plurality of circuit components are mounted on the printed wiring board, and wiring line patterns for connecting the circuit components are formed on each layer, the first to fourth coils 3, 4, 7, 8 may be formed using the wiring line patterns. Since the respective layers of the printed wiring board are formed with an insulating layer 5 being disposed between adjacent layers, the insulating layer 5 described above may be formed easily.

A plurality of sets of the first to fourth coils 3, 4, 7, and 8 may be formed on the semiconductor substrate or in the printed wiring board.

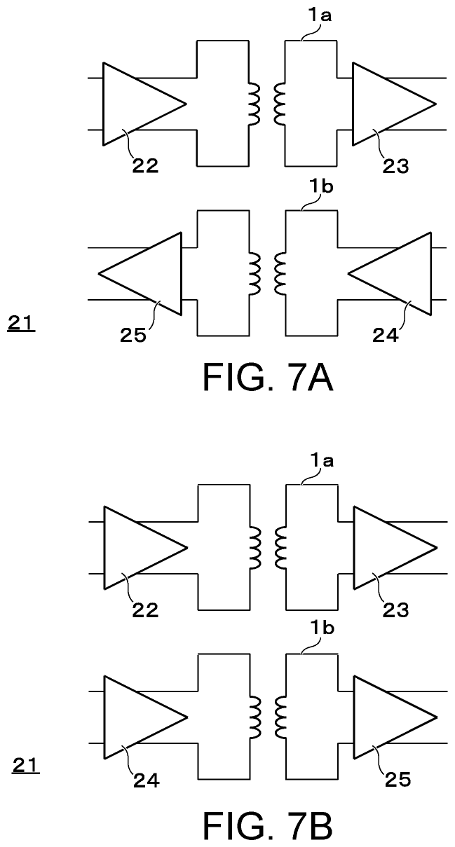

The transformer 1 according to the first embodiment may be used in a signal transmission system. FIG. 7A is a block diagram illustrating a first example of a signal transmission system 21. The signal transmission system 21 shown in FIG. 7A includes a first transmitter 22, a first receiver 23, a second transmitter 24, a second receiver 25, and the transformer 1 according to the first embodiment. The first transmitter 22 and the second transmitter 24 are also called “differential driver.” The first receiver 23 and the second receiver 25 are also called “differential receiver.”

The first transmitter 22 transmits first differential signals to the ends of the first coil 3 of the transformer 1. The first differential signals are transmitted from the first coil 3 to the third coil 7 of the transformer 1 in an electrically isolated manner. The first receiver 23 receives the first differential signals from the third coil 7.

The second transmitter 24 transmits second differential signals to the ends of the fourth coil 8 of the transformer 1. The second differential signals are transmitted from the fourth coil 8 to the second coil 4 of the transformer 1 in an electrically isolated manner. The second receiver 25 receives the second differential signals from the second coil 4.

Thus, the transformer 1 according to the first embodiment includes a first transformer part 1a and a second transformer part 1b, each of which transmits a different set of differential signals in an electrically isolated manner.

FIG. 7B is a block diagram illustrating a second example of the signal transmission system 21. The signal transmission system 21 shown in FIG. 7B includes the same components as the signal transmission system 21 shown in FIG. 7A, but the wire connection of the second transformer part 1b is different. The second transmitter 24 transmits the second differential signals to the ends of the second coil 4 of the transformer 1. The second differential signals are transmitted from the second coil 4 to the fourth coil 8 of the transformer 1 in an electrically isolated manner. The second receiver 25 receives the second differential signals from the fourth coil 8.

Thus, one of the first coil 3 and the third coil 7 of the transformer 1 may be connected to the first transmitter 22 and the other may be connected to the first receiver 23 in this embodiment. Similarly, one of the second coil 4 and the fourth coil 8 may be connected to the second transmitter 24, and the other may be connected to the second receiver 25.

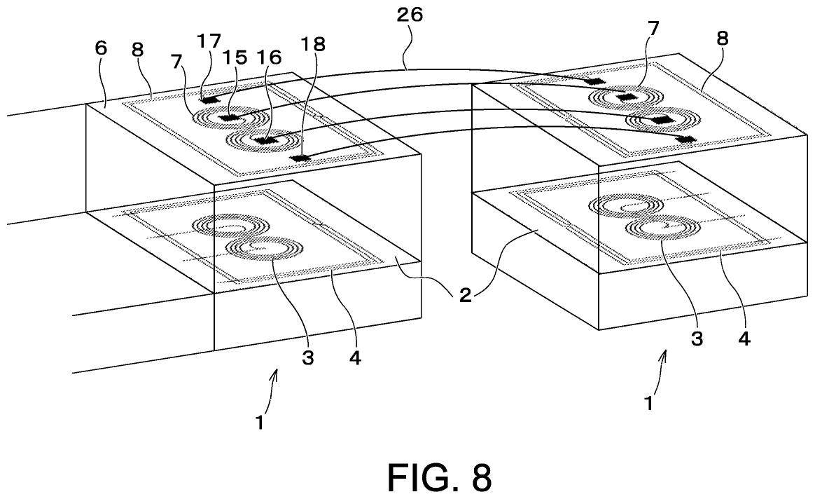

FIG. 8 is a perspective view for explaining an example, in which two transformers 1 according to the first embodiment are used to improve the breakdown voltage. In FIG. 8, the two transformers 1 are arranged to be adjacent to each other, and the corresponding pads of the second surfaces 6, for example, of the transformers 1 are connected by bonding wires 26 or the like. Two sets of differential signals are transmitted by using the two transformers 1 in FIG. 8. The first surface 2 and the second surface 6 of each transformer 1 shown in FIG. 8 are electrically isolated, and the two transformers 1 are also electrically isolated from each other. Therefore, the differential signals are transmitted in a doubly isolated manner.

The two transformers 1 shown in in FIG. 8, the first and second transmitters 22 and 24, and the first and second receivers 23 and 25 may be connected in either the manner shown in FIG. 7A or the manner shown in FIG. 7B.

The double isolation structure shown in FIG. 8 may be housed in a single semiconductor package, for example. In this case, a first support substrate on which one of the transformers 1 is mounted and a second support substrate on which the other is mounted are separately disposed on a main substrate, and the corresponding pads on the second surfaces 6 of the transformers 1 may be connected with the bonding wires 26.

The double isolation structure shown in FIG. 8 may also be mounted on a printed wiring board, for example. In this case, a first support layer on which one of the transformers 1 is mounted and a second support layer on which the other is mounted are separately arranged on a printed wiring board including multiple layers, and the corresponding pads on the second surfaces 6 of the transformers 1 may be connected with wiring line patterns.

The shape and the number of turns of each of the second coil 4 and the fourth coil 8 of the transformer 1 according to the first embodiment may be arbitrarily determined. The second coil 4 and the fourth coil 8 do not necessarily surround the entire length of the periphery of the first coil 3 and the third coil 7. They may surround at least a part of the first coil 3 and the third coil 7.

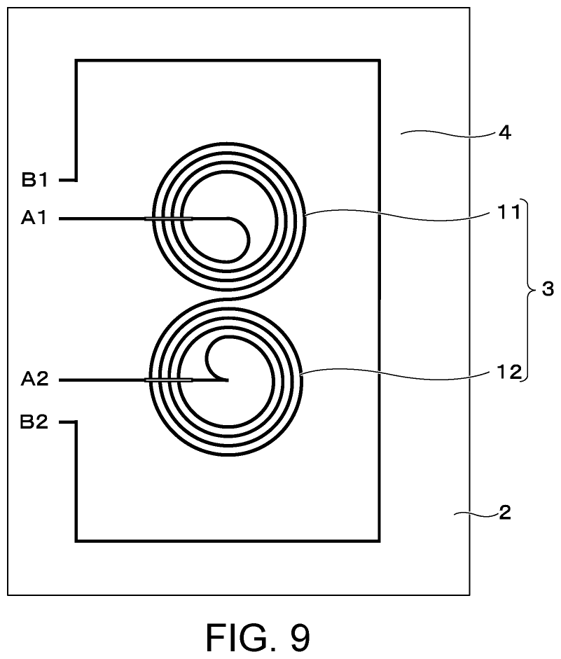

FIG. 9 is a diagram illustrating a first modification of the first coil 3 and the second coil 4 on the first surface 2. The second coil 4 shown in FIG. 9 has a single turn. The second coil 4 shown in FIG. 9 is not positioned in an area where lead lines extend from the first coil 3. Therefore, the second coil 4 is disposed on only a part of one side in the four sides of a rectangle surrounding the first coil 3.

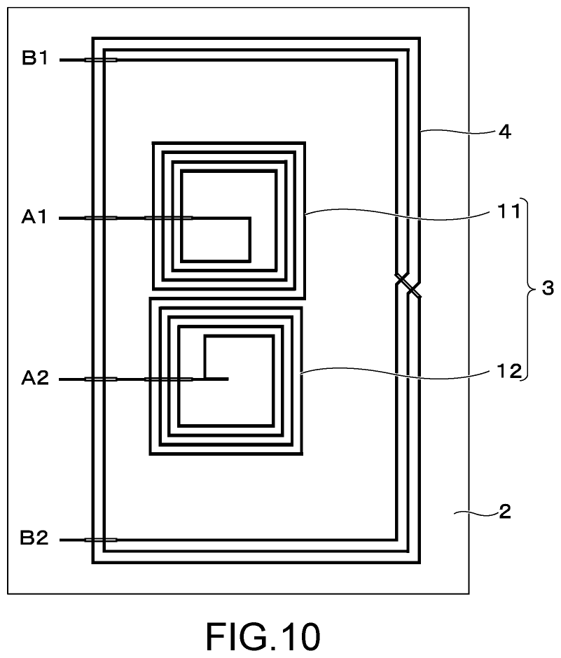

FIG. 10 is a diagram illustrating a second modification of the first coil 3 and the second coil 4 on the first surface 2. In FIG. 10, the first coil 3 and the second coil 4 have a rectangular shape. The shape of the first coil 3 and the second coil 4 may be an arbitrary polygonal shape or an arbitrary curved shape, instead of the rectangular shape, as long as magnetic fluxes are generated therein.

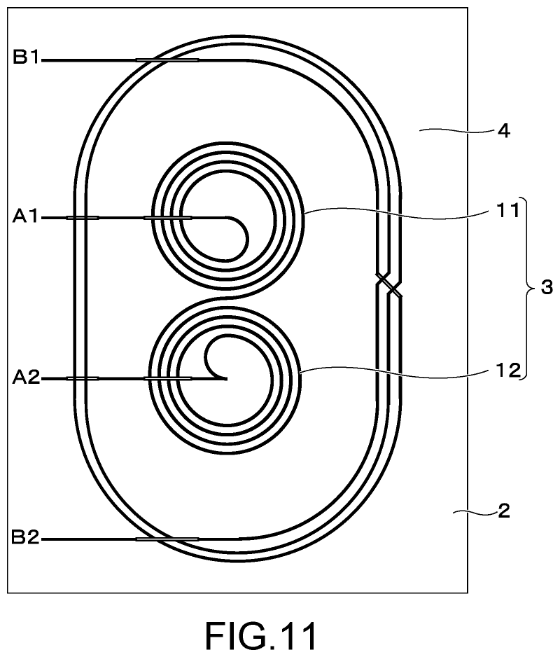

FIG. 11 is a diagram illustrating a third modification of the first coil 3 and the second coil 4 on the first surface 2. In FIG. 11, the second coil 4 extends like a track.

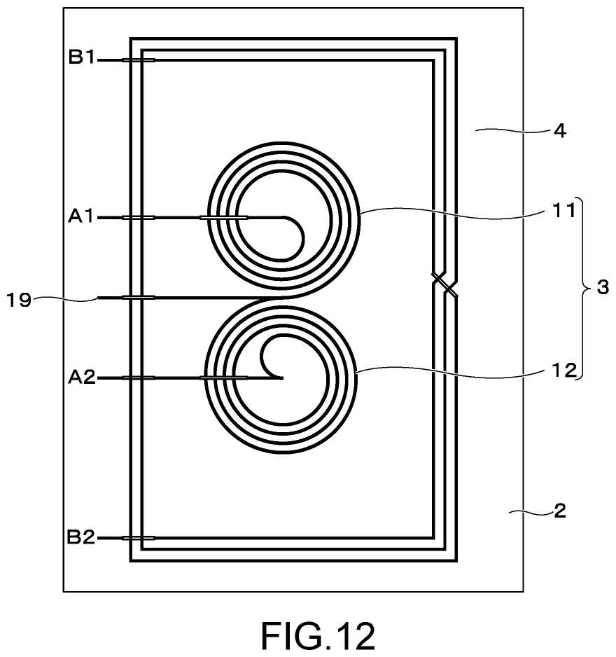

FIG. 12 is a diagram illustrating an example in which a tap terminal 19 is disposed on a path connecting the first coil 3 and the second coil 4 on the first surface 2. The tap terminal 19 is intended to remove power supply noise or common mode noise, and disposed on the midpoint of the transformer 1. The tap terminal 19 is set at the power supply voltage or the ground voltage.

Although FIGS. 9 to 12 show the modifications of the first coil 3 and the second coil 4 on the first surface 2, the third coil 7 and the fourth coil 8 are preferably arranged on the second surface 6 in accordance with the shapes and the positions of the first coil 3 and the second coil 4. The same can be said for the tap terminal 19.

As described above, the second coil 4 is arranged to surround the first coil 3 on the first surface 2, and the fourth coil 8 is arranged to surround the third coil 7 on the second surface 6 that is vertically adjacent to the first surface 2 with the insulating layer 5 disposed therebetween, so that when a current is caused to flow through the first coil 3, the magnetic fluxes generated by the first coil 3 are canceled in the second coil 4 but induce an electromotive force in the third coil 7 in the first embodiment. The winding structure is determined so that, when a current is caused to flow through the second coil 4, no electromotive force is induced in the first coil 3 but an electromotive force is induced in the fourth coil 8. Accordingly, two sets of differential signals may be transmitted in an electrically isolated manner in a small area.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A transformer comprising:
a first coil disposed on a first surface;
a second coil disposed on the first surface so as to surround at least a part of the first coil;
a third coil disposed on a second surface that is vertically adjacent to the first surface with an insulating layer being disposed between the first surface and the second surface; and
a fourth coil disposed on the second surface so as to surround at least a part of the third coil,
wherein when a current is caused to flow through the first coil, the first coil generates magnetic fluxes that pass through the first coil in opposite directions, the magnetic fluxes inducing an electromotive force in the third coil,
wherein when the current is caused to flow through the first coil, the magnetic fluxes generated by the first coil pass through the first coil in opposite directions, the magnetic fluxes causing electromotive forces induced in the second coil and the fourth coil to be canceled;
wherein when a current is caused to flow through the second coil, the second coil generates magnetic fluxes that pass through the second coil in a single direction, the magnetic fluxes causing an electromotive force induced in the first coil and the electromotive force induced in the third coil to be canceled, and
wherein when the current is caused to flow through the second coil, the magnetic fluxes passing through the second coil in the single direction induce the electromotive force in the fourth coil.

2. The transformer according to claim 1,
wherein when a current is caused to flow through the third coil, the third coil generates magnetic fluxes that pass through the third coil in opposite directions, the magnetic fluxes inducing the electromotive force in the first coil,
wherein when the current is caused to flow through the third coil, the magnetic fluxes passing through the third coil in the opposite directions cause the electromotive forces induced in the second coil and the fourth coil to be canceled,
wherein when a current is caused to flow through the fourth coil, the fourth coil generates magnetic fluxes that pass through the fourth coil in a single direction, the magnetic fluxes causing the electromotive forces induced in the first coil and the third coil to be canceled, and
wherein when the current is caused to flow through the fourth coil, the magnetic fluxes passing through the fourth coil in the single direction induce the electromotive force in the second coil.

3. The transformer according to claim 1,
wherein the first coil includes a first winding part and a second winding part that are connected in series and wound in opposite directions,
wherein the second coil is arranged to surround at least a part of the first winding part and the second winding part,
wherein the third coil includes a third winding part and a fourth winding part that are connected in series and wound in opposite directions, and
wherein the fourth coil is arranged to surround at least a part of the third winding part and the fourth winding part.

4. The transformer according to claim 3,
wherein the first winding part and the second winding part are arranged so that when the current is caused to flow through the first coil, a direction of a magnetic flux passing through the first winding part and a direction of a magnetic flux passing through the second winding part are opposite to each other, and that when the current is caused to flow through the second coil, the magnetic fluxes pass through the first winding part and the second winding part in a single direction and cause the electromotive force induced in the first coil to be canceled, and
wherein the third winding part and the fourth winding part are arranged so that when the current is caused to flow through the first coil, the magnetic flux passing through the first winding part and the magnetic flux passing through the second winding part induce the electromotive force in the third coil, and when the current is caused to flow through the second coil, the magnetic flux passing through the third winding part and the magnetic flux passing through the fourth winding part cause the electromotive force induced in the third coil to be canceled.

5. The transformer according to claim 3,
wherein the third winding part and the fourth winding part are arranged so that when the current is caused to flow through the third coil, a direction of a magnetic flux passing through the third winding part and a direction of a magnetic flux passing through the fourth winding part are opposite to each other, and that when the current is caused to flow through the fourth coil, the magnetic fluxes pass through the third winding part and the fourth winding part in a single direction and cause the electromotive force induced in the third coil to be canceled, and
wherein the first winding part and the second winding part are arranged so that when the current is caused to flow through the third coil, the magnetic flux passing through the third winding part and the magnetic flux passing through the fourth winding part induce the electromotive force in the first coil, and that when the current is caused to flow through the fourth coil, the magnetic flux passing through the first winding part and the magnetic flux passing through the second winding part cause the electromotive force induced in the first coil to be canceled.

6. The transformer according to claim 3,
wherein the first winding part and the second winding part include conductive members that are rotationally symmetric, mirror symmetric, axisymmetric, or point symmetric,
wherein the third winding part and the fourth winding part include conductive members that are rotationally symmetric, mirror symmetric, axisymmetric, or point symmetric, and
wherein each of the conductive members includes at least one of a curved portion and a linear portion that is bent at two or more points.

7. The transformer according to claim 3, further comprising a tap terminal connected to at least one of a path connecting the first winding part and the second winding part and a path connecting the third winding part and the fourth winding part.

8. The transformer according to claim 1,
wherein a first transmission unit configured to transmit first differential signals is connected to one of the first coil and the third coil, and a first reception unit configured to receive the first differential signals is connected to the other of the first coil and the third coil, and
wherein a second transmission unit configured to transmit second differential signals is connected to one of the second coil and the fourth coil, and a second reception unit configured to receive the second differential signals is connected to the other of the second coil and the fourth coil.

9. The transformer according to claim 1,
wherein the transformer comprises a first layer, the insulating layer, and a second layer stacked on a semiconductor substrate,
wherein the second coil is disposed on the first surface of the first layer so as to surround at least a part of the first coil,
wherein the fourth coil is disposed on the second surface of the second layer so as to surround at least a part of the third coil,
wherein the first coil and the second coil comprise conductive patterns on the first surface, and
wherein the third coil and the fourth coil comprise conductive patterns on the second surface.

10. The transformer according to claim 1,
wherein the transformer comprises a printed wiring board of multiple layers comprising a first layer, the insulating layer and a second layer,
wherein the second coil is disposed on the first surface of the first layer so as to surround at least a part of the first coil,
wherein the fourth coil is disposed on the second surface of the second layer so as to surround at least a part of the third coil,
wherein the first coil and the second coil comprise conductive patterns on the first surface, and
wherein the third coil and the fourth coil comprise conductive patterns on the second surface.

11. A signal transmission system comprising:
a transformer configured to transmit first differential signals in an electrically isolated manner, and second differential signals in an electrically isolated manner;
a first transmitter configured to transmit the first differential signals to the transformer;
a first receiver configured to receive the first differential signals transmitted by the transformer;
a second transmitter configured to transmit the second differential signals to the transformer; and
a second receiver configured to receive the second differential signals transmitted by the transformer,
wherein the transformer includes:
a first coil disposed on a first surface;
a second coil disposed on the first surface so as to surround at least a part of the first coil;
a third coil disposed on a second surface that is vertically adjacent to the first surface with an insulating layer being disposed between the first surface and the second surface; and
a fourth coil disposed on the second surface so as to surround at least a part of the third coil,
wherein when a current is caused to flow through the first coil, the first coil generates magnetic fluxes that pass through the first coil in opposite directions, the magnetic fluxes inducing an electromotive force in the third coil,
wherein when the current is caused to flow through the first coil, the magnetic fluxes generated by the first coil pass through the first coil in opposite directions, the magnetic fluxes causing electromotive forces induced in the second coil and the fourth coil to be canceled;
wherein when a current is caused to flow through the second coil, the second coil generates magnetic fluxes that pass through the second coil in a single direction, the magnetic fluxes causing an electromotive force induced in the first coil and the electromotive force induced in the third coil to be canceled, and
wherein when the current is caused to flow through the second coil, the magnetic fluxes passing through the second coil in the single direction induce the electromotive force in the fourth coil.

12. The signal transmission system according to claim 11,
wherein when a current is caused to flow through the third coil, the third coil generates magnetic fluxes that pass through the third coil in opposite directions, the magnetic fluxes inducing the electromotive force in the first coil,
wherein when the current is caused to flow through the third coil, the magnetic fluxes passing through the third coil in the opposite directions cause the electromotive forces induced in the second coil and the fourth coil to be canceled,
wherein when a current is caused to flow through the fourth coil, the fourth coil generates magnetic fluxes that pass through the fourth coil in a single direction, the magnetic fluxes causing the electromotive forces induced in the first coil and the third coil to be canceled, and
wherein when the current is caused to flow through the fourth coil, the magnetic fluxes passing through the fourth coil in the single direction induce the electromotive force in the second coil.

13. The signal transmission system according to claim 11, wherein the first coil includes a first winding part and a second winding part that are connected in series and wound in opposite directions,
wherein the second coil is arranged to surround at least a part of the first winding part and the second winding part,
wherein the third coil includes a third winding part and a fourth winding part that are connected in series and wound in opposite directions, and
wherein the fourth coil is arranged to surround at least a part of the third winding part and the fourth winding part.

14. The signal transmission system according to claim 13,
wherein the first winding part and the second winding part are arranged so that when the current is caused to flow through the first coil, a direction of a magnetic flux passing through the first winding part and a direction of a magnetic flux passing through the second winding part are opposite to each other, and that when the current is caused to flow through the second coil, the magnetic fluxes pass through the first winding part and the second winding part in a single direction and cause the electromotive force induced in the first coil to be canceled, and
wherein the third winding part and the fourth winding part are arranged so that when the current is caused to flow through the first coil, the magnetic flux passing through the first winding part and the magnetic flux passing through the second winding part induce the electromotive force in the third coil, and when the current is caused to flow through the second coil, the magnetic flux passing through the third winding part and the magnetic flux passing through the fourth winding part cause the electromotive force induced in the third coil to be canceled.

15. The signal transmission system according to claim 13,
wherein the third winding part and the fourth winding part are arranged so that when the current is caused to flow through the third coil, a direction of a magnetic flux passing through the third winding part and a direction of a magnetic flux passing through the fourth winding part are opposite to each other, and that when the current is caused to flow through the fourth coil, the magnetic fluxes pass through the third winding part and the fourth winding part in a single direction and cause the electromotive force induced in the third coil to be canceled, and
wherein the first winding part and the second winding part are arranged so that when the current is caused to flow through the third coil, the magnetic flux passing through the third winding part and the magnetic flux passing through the fourth winding part induce the electromotive force in the first coil, and that when the current is caused to flow through the fourth coil, the magnetic flux passing through the first winding part and the magnetic flux passing through the second winding part cause the electromotive force induced in the first coil to be canceled.

16. The signal transmission system according to claim 13,
wherein the first winding part and the second winding part include conductive members that are rotationally symmetric, mirror symmetric, axisymmetric, or point symmetric,
wherein the third winding part and the fourth winding part include conductive members that are rotationally symmetric, mirror symmetric, axisymmetric, or point symmetric, and
wherein each of the conductive members includes at least one of a curved portion and a linear portion that is bent at two or more points.

17. The signal transmission system according to claim 13, further comprising a tap terminal connected to at least one of a path connecting the first winding part and the second winding part and a path connecting the third winding part and the fourth winding part.

18. The signal transmission system according to claim 11,
wherein a first transmission unit configured to transmit first differential signals is connected to one of the first coil and the third coil, and a first reception unit configured to receive the first differential signals is connected to the other of the first coil and the third coil, and
wherein a second transmission unit configured to transmit second differential signals is connected to one of the second coil and the fourth coil, and a second reception unit configured to receive the second differential signals is connected to the other of the second coil and the fourth coil.

19. The signal transmission system according to claim 11,
wherein the transformer comprises a first layer, the insulating layer, and a second layer stacked on a semiconductor substrate,
wherein the second coil is disposed on the first surface of the first layer so as to surround at least a part of the first coil,
wherein the fourth coil is disposed on the second surface of the second layer so as to surround at least a part of the third coil,
wherein the first coil and the second coil comprise conductive patterns on the first surface, and
wherein the third coil and the fourth coil comprise conductive patterns on the second surface.

20. The signal transmission system according to claim 11,
wherein the transformer comprises a printed wiring board of multiple layers comprising a first layer, the insulating layer and a second layer,
wherein the second coil is disposed on the first surface of the first layer so as to surround at least a part of the first coil,
wherein the fourth coil is disposed on the second surface of the second layer so as to surround at least a part of the third coil,
wherein the first coil and the second coil comprise conductive patterns on the first surface, and
wherein the third coil and the fourth coil comprise conductive patterns on the second surface.
